(19) United States
(12) Patent Application Publication
(10) Pub. No.: US 2024/0420345 A1
(43) Pub. Date: Dec. 19, 2024

(54) TARGET TRACKER

(71) Applicant: Mitsubishi Electric Corporation, Tokyo (JP)

(72) Inventors: Tetsutaro YAMADA, Tokyo (JP); Toshihiro ITO, Tokyo (JP); Ryoma YATAKA, Tokyo (JP); Masashi SHIRAISHI, Tokyo (JP); Toshihide SHIMIZU, Tokyo (JP)

(73) Assignee: Mitsubishi Electric Corporation, Tokyo (JP)

(21) Appl. No.: 18/823,300

(22) Filed: Sep. 3, 2024

Related U.S. Application Data
(63) Continuation of application No. PCT/JP2022/013785, filed on Mar. 24, 2022.

(51) Int. Cl. G06T 7/246; G06T 7/60; G06T 7/73

(52) U.S. Cl. CPC G06T 7/248; G06T 7/60; G06T 7/74; G06T 2207/30256

(57) ABSTRACT

A target tracker according to the present disclosure technology includes a feature amount corrector including a dynamic background generator, a background feature amount vector calculator, a complementary space projection matrix calculator, and a projection vector calculator, in which the dynamic background generator generates a moving image of a background by partially adding a background image of a place where a target is not shown in a past image to the moving image in a region of the bounding box in which movement of the target is shown, the background feature amount vector calculator calculates a background feature amount vector on the basis of an image of the background, and the complementary space projection matrix calculator calculates a projection matrix of the background feature amount vector to a complementary space, and the projection vector calculator multiplies a feature amount vector of the target by the projection matrix.

### TECHNICAL FIELD

The matter disclosed in this specification relates to a target tracking technology.

### BACKGROUND ART

A technique for tracking a mobile object such as a ship, an automobile, an aircraft, or a person for the purpose of crime prevention or defense is known.

For example, Patent Literature 1 discloses a target tracking device that does not degrade tracking performance even when there is a blur in an image used for detection and tracking of a target.

### CITATION LIST

### Patent Literatures

Patent Literature 1: WO 2021/171498

### SUMMARY OF INVENTION

### Technical Problem

The present disclosure technology is an improvement of the technique disclosed in Patent Literature 1. Specifically, an object of the present disclosure technology is to provide a target tracking device capable of coping with a change in a portion other than a target, that is, a background portion, in an image in a bounding box enclosing the target in a square box having an exact size when tracking a plurality of targets.

### Solution to Problem

A target tracker according to the present disclosure technology is a target tracker that tracks a plurality of targets by a bounding box. A target tracker according to the present disclosure technology includes a feature amount corrector including a dynamic background generator, a background feature amount vector calculator, a complementary space projection matrix calculator, and a projection vector calculator, in which the dynamic background generator generates a moving image of a background by partially adding a background image of a place where the targets are not shown in a past image to the moving image in a region of the bounding box in which movement of the targets is shown, the background feature amount vector calculator calculates a background feature amount vector by referring to an image of the background, the complementary space projection matrix calculator calculates a projection matrix of the background feature amount vector to a complementary space, and the projection vector calculator multiplies a feature amount vector of the target by the projection matrix.

### Advantageous Effects of Invention

Since the target tracking device according to the present disclosure technology has the above-described configuration, when tracking a plurality of targets, it is possible to cope with a case where a background portion changes in an image in a bounding box surrounding the periphery of the targets.

### BRIEF DESCRIPTION OF DRAWINGS

FIG. 1 is a block diagram illustrating a functional configuration of a target tracking device according to a first embodiment.

FIG. 2 is a block diagram illustrating a functional configuration of a feature amount correcting unit 108 according to the first embodiment.

FIG. 3 is a flowchart illustrating processing steps of the target tracking device according to the first embodiment.

FIG. 4 is a flowchart illustrating detailed processing steps of feature amount correction processing ST100.

FIG. 5 is a diagram describing a problem to be solved by the present disclosure technology.

FIG. 6 is a diagram illustrating a state of generating a moving image of only a background, which is employed to solve the problem by the present disclosure technology.

FIG. 7 is a diagram illustrating aspects of two targets in a feature amount space, which is used to solve a problem by the present disclosure technology.

FIG. 8 is a diagram illustrating an effect of the present disclosure technology in the feature amount space.

FIG. 9 is a block diagram illustrating a functional configuration of a target tracking device according to a second embodiment.

FIG. 10 is a flowchart illustrating processing steps of the target tracking device according to the second embodiment.

FIG. 11 is a diagram describing prediction of a motion of a target in consideration of a vanishing point position in an image handled by the present disclosure technology.

FIG. 12 is a block diagram illustrating a functional configuration of a target tracking device according to a third embodiment.

FIG. 13 is a flowchart illustrating processing steps of the target tracking device according to the third embodiment.

FIG. 14 is a diagram describing a state in which a flow rate for a target is estimated by the present disclosure technology.

FIG. 15 is a hardware configuration diagram No. 1 of the target tracking device according to the present disclosure technology.

FIG. 16 is a hardware configuration diagram No. 2 of the target tracking device according to the present disclosure technology.

FIG. 17 is a hardware configuration diagram No. 3 of the target tracking device according to the present disclosure technology.

### DESCRIPTION OF EMBODIMENTS

The present disclosure technology is an improved technology of the technology described in Patent Literature 1. The correspondence between the components described in Patent Literature 1 and the components used in the present specification is roughly as follows.

| Patent Literature 1 | |
|---|---|
| (WO 2021/171498) | Present Disclosure Technology |
| Target Tracking Device 1, 20, 30 | Target Tracking Device 100 |
| Sensor Unit 2 | Camera 300, |
| Camera 10, | LIDAR 400, or |
| Antenna 12, Transceiver 13, | Antenna 510, Transceiver 520, |
| and A/D Converter 14 | and AD Converter 530 |
| Display Device 3 | Display Device 200 |
| Acquiring Unit 4 | Sensor Observing Unit 102 |
| Detecting Unit 5, 21 | Detecting Unit 104 |
| Predicting Unit 6 | Predicting Unit 110 |
| Correlating Unit 7 | Correlating Unit 114 |
| Feature Amount | Feature Amount Selecting Unit |
| Selecting Unit 8 | 115 |
| Filtering Unit 9 | Feature Amount Filter Unit 116 |

The components according to the present disclosure technology indicated in the table are equivalent to or improved from the corresponding components of Patent Literature 1.

### First Embodiment

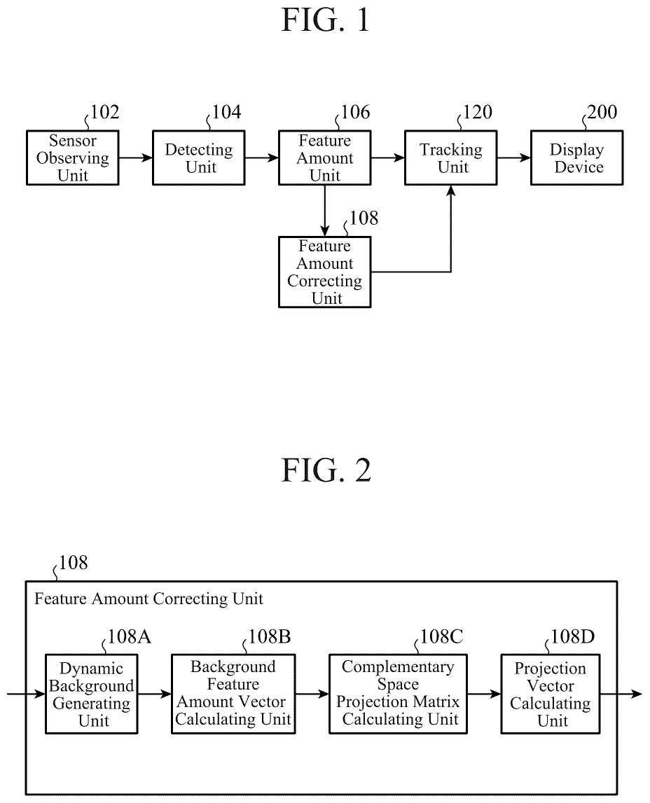

FIG. 1 is a block diagram illustrating a functional configuration of a target tracking device 100 according to a first embodiment. As illustrated in FIG. 1, the target tracking device 100 according to the first embodiment includes a sensor observing unit 102, a detecting unit 104, a feature amount unit 106, a feature amount correcting unit 108, and a tracking unit 120. The elements constituting the target tracking device 100 such as the sensor observing unit 102 are referred to as “components of the target tracking device 100”.

The target tracking device 100 according to the first embodiment may include a display device 200 as a part of the device or may be connected to the display device 200 independent of the device.

Each component of the target tracking device 100 is connected as illustrated in FIG. 1.

### <<Sensor Observing Unit 102>>

The sensor observing unit 102 is a component for observing and acquiring sensor data measured by a sensor used by the target tracking device 100 to track a target.

The sensor used by the target tracking device 100 to track the target may be specifically a camera 300 or a LiDAR 400. Furthermore, the sensor used by the target tracking device 100 to track the target may be a radar or the like including an antenna 510, a transceiver 520, and an AD converter 530.

If the sensor is the camera 300, the sensor data is image data. The image data may be a moving image including a plurality of frames.

The sensor data acquired by the sensor observing unit 102 is transmitted to the detecting unit 104.

### <<Detecting Unit 104>>

The detecting unit 104 is a component for detecting an observed feature amount related to a target in sensor data. In a case where the sensor is the camera 300, the observed feature amount related to the target is, for example, the position and size of the target. The observed feature amount may be one disclosed in Patent Literature 1, for example, a color histogram or a gradient direction histogram.

In a case where the sensor data is an image, the detecting unit 104 may use, for example, a target detection algorithm such as Single Shot Multi-Box Detector (SSD) or You Look Only Once (YOLO).

In a case where the detecting unit 104 is configured by an artificial neural network such as a Convolutional Neural Network (CNN), the observed feature amount may be an amount of a first axis, a second axis, . . . of a feature amount map that is an intermediate product of the artificial neural network.

The observed feature amount (hereinafter, simply referred to as a “feature amount”) detected by the detecting unit 104 is sent to the feature amount unit 106. The feature amount is generally a multi-dimensional variable. The feature amount can be expressed as a vector in a feature amount space (see also FIG. 7). In the present specification, an expression “feature amount vector” is used to emphasize that the feature amount is a vector. Further, the “feature amount” is also used as a term in a case of representing an element of a feature amount vector.

### <<Feature Amount Unit 106>>

The feature amount unit 106 is a component for calculating the “appearance feature amount” of a target. The appearance feature amount is one when the above-described feature amount is roughly divided into three. The three feature amounts are a “position feature amount”, a “size feature amount”, and an “appearance feature amount”.

The action of recognizing a target by a human is performed on the basis of a concept possessed by humans. For example, a human combines a blue portion shown in an upper portion in an image with a concept of “sky”, conceptualizes an operation of “flying” in the “sky”, and recognizes that it is an “aircraft” because it is a “flying target”.

However, a process in which artificial intelligence recognizes a target is different from a human recognition process because the artificial intelligence does not necessarily have a concept possessed by humans. The artificial intelligence changes how to obtain the feature amount depending on what training data set is used in the learning process. For example, in a case where learning is performed with a training data set in which a target 1 always appears at the upper left of the image, the artificial intelligence takes the feature amount in such a manner that the position in the image has meaning. Further, for example, in a case where learning is performed with a training data set in which a target 2 is always shown larger than the target 1 in the image, the artificial intelligence takes a feature amount in such a manner that the size in the image has meaning.

Although not necessarily consistent with the concept possessed by humans, the feature amount taken by the artificial intelligence may be associated with the concept possessed by humans, and for example, the first axis of the feature amount map may be referred to as “position feature amount” on the assumption that the first axis is likely to be related to the position of the target in the image. Similarly, for example, the second axis of the feature amount map may be referred to as “size feature amount” on the assumption that the second axis is likely to be related to the size of the target in the image.

The concept possessed by humans includes various things in addition to the position and size in the image. For example, a human concept includes what kind of color is used for a target, what color arrangement pattern is used, and what texture (hard or soft) of the target is used. Such a concept is collectively referred to as “appearance”, and among axes of the feature amount map, an axis that is likely to be related to “appearance” is referred to as “appearance feature amount”.

In order to calculate the appearance feature amount, the feature amount unit 106 may use a histogram of RGB or HSV for an image, a high-dimensional feature amount based on Metric Learning, or the like.

The appearance feature amount calculated by the feature amount unit 106 is sent to the tracking unit 120.

### <<Tracking Unit 120>>

The tracking unit 120 is a component that performs processing for the target tracking device 100 to track a target.

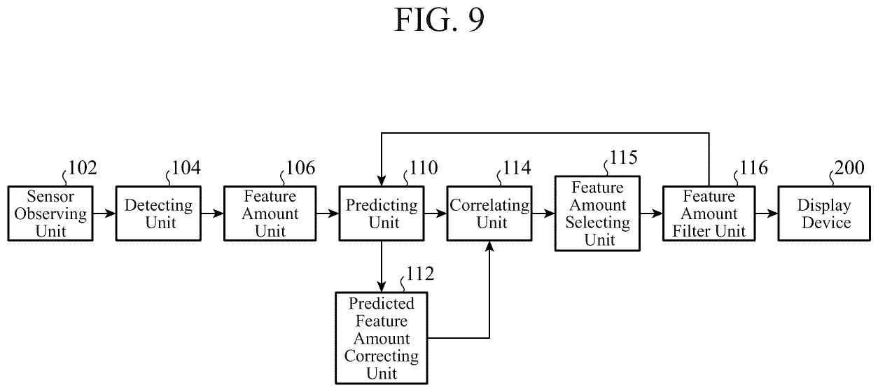

The tracking unit 120 includes a predicting unit 110, a correlating unit 114, a feature amount selecting unit 115, and a feature amount filter unit 116. Note that, as illustrated in FIG. 9 according to a second embodiment, the components in the tracking unit 120 are connected in series.

### <<Predicting Unit 110 Constituting Tracking Unit 120>>

The predicting unit 110 included in the tracking unit 120 is a component for calculating a predicted value of the feature amount at the current time that has not yet been determined on the basis of only the feature amount at the past time acquired from the detecting unit 104. The predicted value of the feature amount (hereinafter, referred to as a “predicted feature amount”) calculated by the predicting unit 110 is sent to the correlating unit 114.

### <<Correlating Unit 114 Constituting Tracking Unit 120>>

The correlating unit 114 constituting the tracking unit 120 is a component for comparing the predicted feature amount acquired from the predicting unit 110 with the feature amount at the current time and calculating a correlation.

In a case where there is a plurality of targets to be tracked by the target tracking device 100 according to the present disclosure technology and their respective traffic lines are tracked at the same time, the targets appear to overlap each other, and a problem such as mixed up or a loss of traffic lines may occur.

It can be said that the correlating unit 114 is a component for preventing the problem such as mixed up from occurring as much as possible. For example, it is assumed that there are two targets to be tracked, that is, a target 1 and a target 2. Among the predicted feature amounts acquired from the predicting unit 110, a prediction feature amount related to the target 1 is referred to as a predicted feature amount 1, a prediction feature amount related to the target 2 is referred to as a predicted feature amount 2, and both are distinguished. When there is a correlation between a certain feature amount (X) and the predicted feature amount 2 among some feature amounts at the current time, the correlating unit 114 can determine that the certain feature amount (X) is a feature amount for the target 2.

As described above, the correlating unit 114 determines a plausible combination of the locus of the traffic line up to current time and the feature amount at current time, for each of the targets.

The correlating unit 114 may use a correlation algorithm such as Global Nearest Neighbor (GNN) or Multiple Hypothesis Tracking (MHT) as means for calculating the correlation.

### <<Feature Amount Selecting Unit 115 Constituting Tracking Unit 120>>

The feature amount selecting unit 115 constituting the tracking unit 120 is a component that selects a feature amount to be filtered in the feature amount filter unit 116 and outputs the selected feature amount to the feature amount filter unit 116. The selection of the feature amount to be filtered is performed on the basis of the predicted feature amount and the feature amount at the current time.

### <<Feature Amount Filter Unit 116 Constituting Tracking Unit 120>>

The feature amount filter unit 116 constituting the tracking unit 120 is a component that receives the feature amount at the current time as input and outputs an estimated value of the feature amount at the next time. The term “next time” used here means “next time in discrete time for each processing cycle” when the tracking unit 120 is assumed to be implemented by a processing circuit. For example, when the current time is represented by a subscript k, the next time is represented by a subscript k+1. The processing cycle may be determined on the basis of a frame rate in a case where the target tracking device 100 is processing a moving image. In a case where a sampling rate for the processing is the same as the frame rate, a portion expressed as “k-th time” or “time k” may be read as “k-th frame” or “frame k”. The time from time k to time k+1 when considered as a continuous time is referred to as a sampling period.

The feature amount filter unit 116 may use a Kalman filter, a nonlinear Kalman filter, a particle filter, a sequential Monte Carlo filter, a bootstrap filter, an a-B filter, or the like as means for outputting the estimated value of the feature amount of the next time.

The estimated value of the feature amount of the next time calculated by the feature amount filter unit 116 is transmitted to the display device 200.

### <<Feature Amount Correcting Unit 108>>

The feature amount correcting unit 108 is a component for correcting the feature amount sent from the feature amount unit 106. The feature amount correcting unit 108 provided in the target tracking device 100 is an improvement from the technique disclosed in Patent Literature 1.

FIG. 2 is a block diagram illustrating a functional configuration of the feature amount correcting unit 108 according to the first embodiment. As illustrated in FIG. 2, the feature amount correcting unit 108 includes a dynamic background generating unit 108A, a background feature amount vector calculating unit 108B, a complementary space projection matrix calculating unit 108C, and a projection vector calculating unit 108D. Details of the processing content of the feature amount correcting unit 108 will be apparent from the following description.

The feature amount (hereinafter, referred to as “corrected feature data”) corrected by the feature amount correcting unit 108 is sent to the tracking unit 120.

### <<Processing Content of Target Tracking Device 100 According to First Embodiment>>

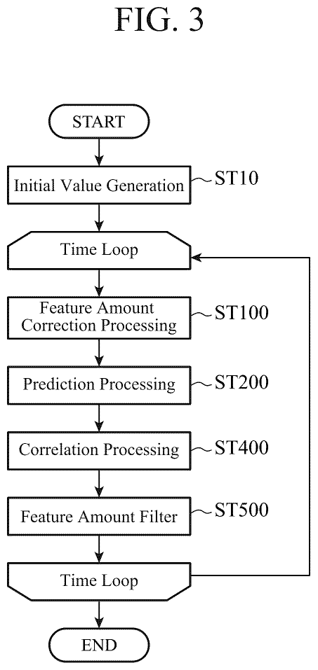

FIG. 3 is a flowchart illustrating processing steps of the target tracking device 100 according to the first embodiment. As illustrated in FIG. 3, the processing steps of the target tracking device 100 include initial value generation ST10, feature amount correction processing ST100, prediction processing ST200, correlation processing ST400, and a feature amount filter ST500.

The initial value generation ST10 is a processing step performed by the target tracking device 100. In the initial value generation ST10, the target tracking device 100 generates initial values for performing various calculations.

The feature amount correction processing ST100 is a processing step performed by the feature amount correcting unit 108.

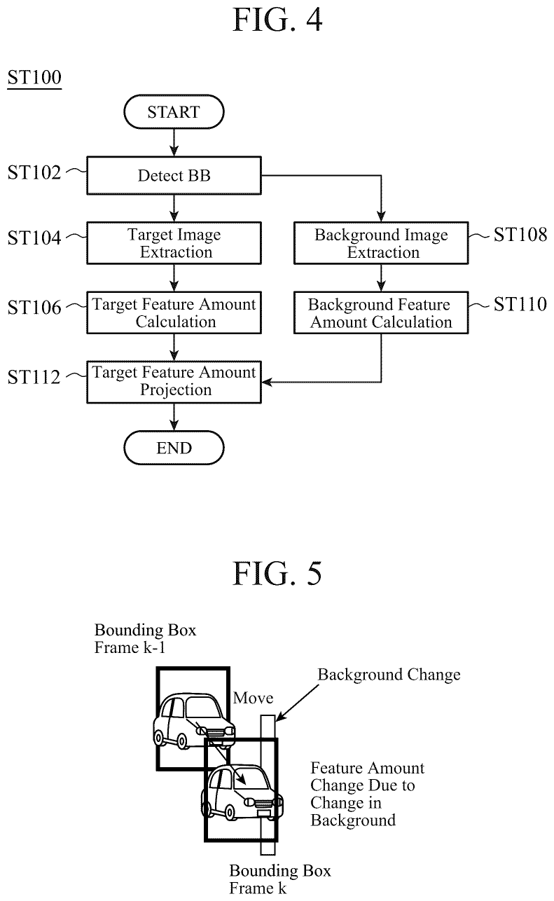

FIG. 4 is a flowchart illustrating detailed processing steps of the feature amount correction processing ST100 performed by the feature amount correcting unit 108. As illustrated in FIG. 4, the feature amount correction processing ST100 includes BB detection ST102, target image extraction ST104, target feature amount calculation ST106, background image extraction ST108, background feature amount calculation ST110, and target feature amount projection ST112. The feature amount correction processing ST100 is a configuration of parallel processing that performs processing including the background image extraction ST108 and the background feature amount calculation ST110 in parallel with processing including the BB detection ST102, the target image extraction ST104, and the target feature amount calculation ST106.

The fact that the detailed processing step of the feature amount correction processing ST100 illustrated in FIG. 4 includes the parallel processing including the background image extraction ST108 and the background feature amount calculation ST110 is an improvement from the technology disclosed in Patent Literature 1.

The BB detection ST102 is a processing step performed by the detecting unit 104. The alphabet of “BB” in the BB detection ST102 means a bounding box, and is derived from the initials when expressed in English. The flowchart illustrated in FIG. 4 is based on the premise that a target tracked by the target tracking device 100 is surrounded by a bounding box and displayed. In the BB detection ST102, the detecting unit 104 detects the bounding box surrounding the target.

The target image extraction ST104 is a processing step performed by the detecting unit 104. In target image extraction ST104, the detecting unit 104 extracts an image in which a target is shown.

The target feature amount calculation ST106 is a processing step performed by the feature amount unit 106. In the target feature amount calculation ST106, the feature amount unit 106 calculates a feature amount related to a target.

The target feature amount calculation ST106 can also be expressed by the following mathematical expression.

$$V ( k , i ) = f ( {img}_{k -} {BB}_{i} ) \qquad ( 1 )$$

Note that V(k,i) on the left side represents the feature amount vector for the i-th target at time k, the function f( ) on the right side represents the target feature amount calculation ST106, and img_{k_}BBᵢ as an argument on the right side represents the image in the bounding box for the i-th target at time k. More strictly speaking, V(k,i) is a feature amount vector for an image in a bounding box surrounding the i-th target at time k.

In the target feature amount calculation ST106, that is, an artificial intelligence such as a learned CNN may be used to implement the function f( ) Further, when the function f( ) is implemented, information of RGB or HSV histograms in the target image may be used.

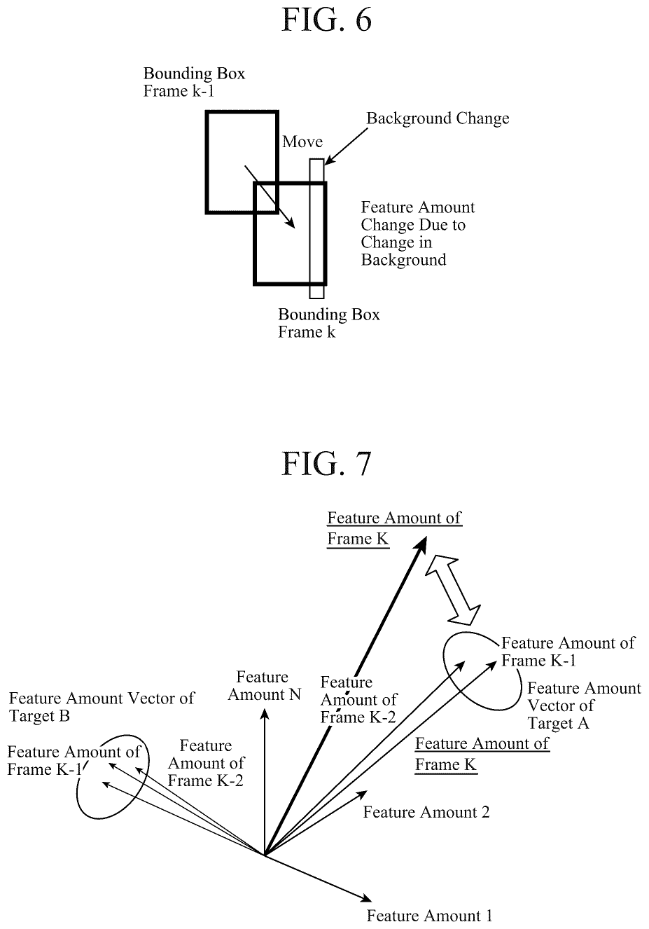

The background image extraction ST108 is a processing step performed by the dynamic background generating unit 108A of the feature amount correcting unit 108. In the background image extraction ST108, the dynamic background generating unit 108A generates a dynamic image of the background, that is, a moving image of only the background, on the basis of an input image including a past image (see also FIGS. 5 and 6). In the present specification, the term “background” is used in the same meaning as “other than a target”.

The background image extraction ST108 can also be expressed by the following mathematical expression.

$${C}_{k} ( x , y ) = λ img ( x , y ) + ( 1 - λ ) {C}_{k - 1} ( x , y ) \qquad ( 2 )$$

Note that Cₖ(x, y) on the left side represents the background image at the pixel coordinates (x, y) at time k, A on the right side represents the weight parameter, and img(x, y) on the right side represents the image at the pixel coordinates (x, y) cut out from the video at the latest time. Expression (2) represents processing contents for only a region other than the region surrounded by the bounding box.

The purpose of the background image extraction ST108, that is, Expression (2) is to generate a moving image of only a background, that is, Cₖ, k=0, 1, 2 . . . in which no target is shown. In other words, the dynamic background generating unit 108A generates a moving image of only the background by partially adding the background image of a portion where the target is not shown in the past image to the moving image showing the movement of the target.

In the region surrounded by the bounding box, the dynamic background generating unit 108A may perform semantic segmentation in order to separate the target and other than the target (that is, “background”) on a pixel-by-pixel basis.

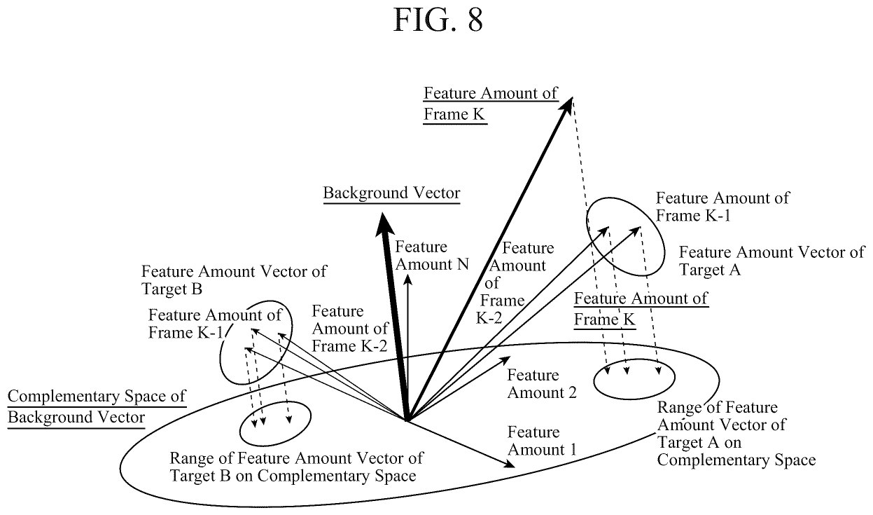

The background feature amount calculation ST110 is a processing step performed by the background feature amount vector calculating unit 108B of the feature amount correcting unit 108. In the background feature amount calculation ST110, the background feature amount vector calculating unit 108B calculates a background feature amount vector (V_{bg}) on the basis of the background image (Cₖ) (see also FIG. 8). Note that, in V_{bg} meaning a background feature amount vector, a subscript bg is derived from initials of “background” which is the English notation for “background”. The background feature amount vector (V_{bg}) can be expressed as follows using the same function f( ) as in the Expression (1).

$${V}_{bg} ( k , i ) = f ( {C}_{k -} {BB}_{i} ) \qquad ( 3 )$$

Note that C_{k_}BBᵢ on the right side is a partial image of the background image (Cₖ) at time k, and indicates such an image corresponding to the position of the region of the bounding box surrounding the i-th target. The size of C_{k_}BBᵢ is the same as the bounding box surrounding the i-th target.

The target feature amount projection ST112 is a processing step performed by the complementary space projection matrix calculating unit 108C and the projection vector calculating unit 108D of the feature amount correcting unit 108 (see also FIG. 8).

In the target feature amount projection ST112, the complementary space projection matrix calculating unit 108C calculates the following projection matrix (bold P).

$$P = {A ( {A}^{T} A )}^{- 1} {A}^{T} \qquad ( 4 )$$

Here, it is assumed that the bold A is a matrix of n columns configured by horizontally arranging n vertical vectors a₁, a₂, . . . aₙ, and A^{T}A is regular. A superscript T in A^{T} represents transposition. A space formed by the n vertical vectors a₁, a₂, . . . , aₙ is a complementary space of the background feature amount vector (V_{bg}). The n vertical vectors a₁, a₂, . . . , aₙ can be obtained by an outer product of the basis vector of the feature amount space and the background feature amount vector (V_{bg}). Since the dimension of the complementary space of a certain vector in the Nth-order feature amount space is N−1, n is N−1. The basis vectors in the Nth-order feature amount space are represented by e₁, e₂, . . . , eₙ. Among the N vectors obtained by the outer product of the basis vector (e₁, e₂, . . . , eₙ) of the Nth-order feature amount space and the background feature amount vector (V_{bg}), N−1 vectors of which the magnitude is not 0 only needs to be set as n vertical vectors a₁, a₂, . . . , aₙ. Note that a case where the magnitude of the vector obtained by the outer product of the basis vector (for example, the i-th e₁) and the background feature amount vector (V_{bg}) is 0 is a case where the directions of the basis vector (e₁) and the background feature amount vector (V_{bg}) are the same, and a case where the background feature amount vector (V_{bg}) is represented by a scalar multiple of the basis vector (e₁).

Further, if a space in which the background feature amount vector (V_{bg}) can exist (hereinafter, referred to as a “background partial space”) can be empirically known, a space formed by the n vertical vectors a₁, a₂, . . . , aₙ may be used as the complementary space of the background partial space.

In the target feature amount projection ST112, the projection vector calculating unit 108D calculates a correction of the target feature amount vector (V(k,i)) (hereinafter, referred to as a “corrected target feature amount vector”) using the projection matrix (bold P).

$$\hat{V} ( k , i ) := PV ( k , i ) \qquad ( 5 )$$

However, a vector in which a hat is added to V(k,i) on the left side is a corrected target feature amount vector for the i-th target at time k. In other words, the projection vector calculating unit 108D multiplies the projection matrix (P) from the left of the target feature amount vector (V(k,i)). The calculation of the corrected target feature amount vector is performed for all times (all k) and all targets (all i).

The corrected target feature amount vector calculated by the projection vector calculating unit 108D is sent to the correlating unit 114.

The prediction processing ST200 is a processing step performed by the predicting unit 110. In the prediction processing ST200, the predicting unit 110 predicts the motion of the target on the assumption that the target is performing a uniform linear motion or a uniform turning motion.

The correlation processing ST400 is a processing step performed by the correlating unit 114. In the correlation processing ST400, the correlating unit 114 solves an assignment problem of an existing locus and an observation value.

As described above, the correlating unit 114 determines a plausible combination of the locus of the traffic line up to each current time and the feature amount at each current time for the plurality of targets. The determination of this plausible combination may use cosine similarity. The cosine similarity is given by the following expression.

$$cos \{ \hat{V} ( k , j ) , \hat{V} ( k - 1 , i ) \} = \frac{\hat{V} ( k , j ) \cdot \hat{V} ( k - 1 , i )}{‖ \hat{V} ( k , j ) ‖ ‖ \hat{V} ( k - 1 , i ) ‖} \qquad ( 6 )$$

Expression (6) represents that the cosine similarity is calculated for the corrected target feature amount vector of the i-th target at time k−1 and the j-th corrected target feature amount vector at time k for which any target has not yet been specified. The numerator on the left side of Expression (6) represents an inner product operation of the vector. In addition, an operation surrounded by two vertical lines in the denominator on the left side of Expression (6) means a norm.

The problem solved by the correlating unit 114 can be regarded as an assignment problem of an existing locus and an observation value. The correlating unit 114 may use Munkres algorithm, Murty algorithm, or the Hungarian method as means for solving the assignment problem.

The correlating unit 114 may define a cost function as means for solving the assignment problem. In general, various names such as an evaluation function or an objective function are used as the cost function. The cost function defined by the correlating unit 114 may include a term using a statistical distance with a feature amount vector as an argument.

The correlating unit 114 may use a likelihood ratio as means for solving the assignment problem. The likelihood ratio (L_{i,j}) is given by the following expression.

$${L}_{i , j} = \frac{p ( {D}_{i , j} \vert {H}_{1} )}{p ( {D}_{i , j} \vert {H}_{0} )} \times \frac{p ( {P}_{i , j} \vert {H}_{1} )}{p ( {P}_{i , j} \vert {H}_{0} )} \times \frac{p ( {WL}_{i , j} \vert {H}_{1} )}{p ( {WL}_{i , j} \vert {H}_{0} )} \qquad ( 7 )$$

Here, p(|) represents a probability distribution, H₁ represents an event in which the allocation of the target is correct, and H₀ represents an event in which the allocation of the target is incorrect. More specifically, H₁ represents an event in which the observation value at the current time and the predicted value at the current time estimated from the past observation value are for the same target. H₀ represents an event in which the observation value at the current time and the predicted value at the current time estimated from the past observation value are for different targets. D_{i,j} represents an event in which the combination of the i-th observation value and the j-th predicted value is determined to be the same target from the appearance feature amount. P_{i,j} represents an event in which the combination of the i-th observation value and the j-th predicted value is determined to be the same target from the position in the image. WL_{i,j} represents an event in which the combination of the i-th observation value and the j-th predicted value is determined to be the same target from the size in the image. Note that WL in WL_{i,j} is derived from Width and Length in English meaning width and length.

The feature amount filter ST500 is a processing step performed by the feature amount filter unit 116. In the feature amount filter ST500, the feature amount filter unit 116 outputs an estimated value of a feature amount at the next time using a filter.

FIGS. 5 to 8 are diagrams describing problems to be solved by the present disclosure technology and effects of the present disclosure technology.

FIG. 5 is a diagram describing a problem to be solved by the present disclosure technology. More specifically, FIG. 5 illustrates a phenomenon in which the background in an image in a bounding box surrounding a target candidate changes as the target moves. The region surrounded by the bounding box in this manner may affect identification of the target since the background that is a portion other than the target may change.

FIG. 6 is a diagram illustrating a state of generating a moving image of only a background, which is employed to solve the problem by the present disclosure technology. FIG. 6 illustrates a state in which the dynamic background generating unit 108A virtually generates a moving image of only the background on the basis of the input image including the past image in the background image extraction ST108.

FIG. 7 is a diagram illustrating aspects of two targets in a feature amount space, which is used to solve the problem by the present disclosure technology. FIG. 7 illustrates a state in which the N-dimensional feature amount space is viewed from above as a whole. Each of “feature amount 1”, “feature amount 2”, and “feature amount N” illustrated in FIG. 7 represents a coordinate axis defining an N-dimensional feature amount space. In the feature space illustrated in FIG. 7, a feature amount vector for the target 1 (described as “target A” in FIG. 7) is illustrated on the approximate right side of the drawing, and a feature amount vector for the target 2 (described as “target B” in FIG. 7) is illustrated on the approximate left side of the drawing.

An ellipse (actually an N-dimensional ellipsoid) illustrated in FIG. 7 represents a range in which a feature amount assumed after one sampling period elapses is plotted. That is, if the plot of the feature amount at time k is included in an ellipsoid centered on the plot of the feature amount at time k−1, it is estimated that the two feature amounts relate to the same target.

The thick vector described as “feature amount of the frame k” in FIG. 7 is intended to relate to the target 1 (target A). However, since the plot destination of the thick vector is not in the ellipsoid centered on the plot of the feature amount in the frame k−1 of the target 1, the above estimation that the target is the same does not work.

FIG. 8 is a diagram illustrating an effect of the present disclosure technology in the feature amount space. Compared with FIG. 7, FIG. 8 illustrates that a background vector and a complementary space of the background vector are added. The “background vector” illustrated in FIG. 8 represents a background feature amount vector (V_{bg}) calculated by the background feature amount vector calculating unit 108B in the background feature amount calculation ST110. The “complementary space of the background vector” illustrated in FIG. 8 is a space formed by the above-described n vertical vectors a₁, a₂, . . . , aₙ, and is a complementary space of the background feature amount vector (V_{bg}).

When projected to the complementary space of the background vector (target feature amount projection ST112), the plot destination of the thick vector described as “feature amount of the frame k” in FIG. 8 is in the “range of the feature amount vector of the target A on the complementary space”. This indicates that the above estimation of being the same target works by considering the complementary space of the background vector. By considering in the complementary space of the background vector, the influence of a change other than the target (that is, “background”) in the image in the bounding box is eliminated.

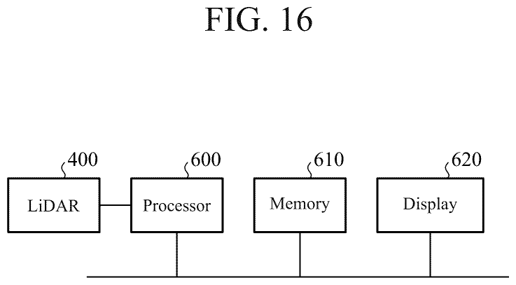

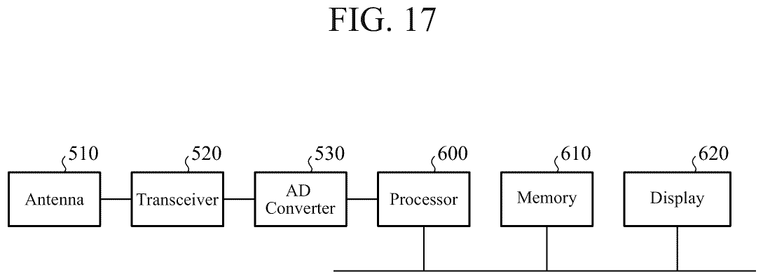

FIGS. 15 to 17 are hardware configuration diagrams of the target tracking device 100 according to the present disclosure technology. FIG. 15 is a hardware configuration diagram of the target tracking device 100 in a case where the camera 300 is used as a target tracking sensor. FIG. 16 is a hardware configuration diagram in a case where a LiDAR 400 is used as the target tracking sensor. FIG. 17 is a hardware configuration diagram in a case where a radar is used as the target tracking sensor. The radar illustrated in FIG. 17 includes the antenna 510, the transceiver 520, and the AD converter 530.

As illustrated in FIGS. 15 to 17, the target tracking device 100 according to the present disclosure technology includes a processor 600, a memory 610, and a display 620 as hardware.

The sensor observing unit 102, the detecting unit 104, the feature amount unit 106, the feature amount correcting unit 108, and the tracking unit 120 in the target tracking device 100 according to the present disclosure technology are implemented by a processing circuit. That is, the target tracking device 100 includes a processing circuit for tracking the target by performing the processing steps illustrated in FIG. 3. The processing circuit is the processor 600 (also referred to as a central processing unit, a central processor, a processing device, an arithmetic device, a microprocessor, a microcomputer, or a digital signal processor) that executes a program stored in the memory 610.

The functions of the sensor observing unit 102, the detecting unit 104, the feature amount unit 106, the feature amount correcting unit 108, and the tracking unit 120 are implemented by software, firmware, or a combination of software and firmware. Software and firmware are described as programs and stored in the memory 610. The processing circuit implements the functions of the respective units by reading and executing the programs stored in the memory 610. That is, the target tracking device 100 according to the present disclosure technology includes the memory 610 for storing a program that results in execution of the processing steps illustrated in FIG. 3 when executed by the processing circuit. In addition, it can also be said that these programs cause a computer to execute procedures or methods of the sensor observing unit 102, the detecting unit 104, the feature amount unit 106, the feature amount correcting unit 108, and the tracking unit 120. Here, the memory 610 may be, for example, a nonvolatile or volatile semiconductor memory such as RAM, ROM, a flash memory, EPROM, or EEPROM. Further, the memory 610 may include a disk such as a magnetic disk, a flexible disk, an optical disk, a compact disk, a mini disk, or a DVD. Furthermore, the memory 610 may be in the form of an HDD or an SSD.

As described above, since the target tracking device 100 according to the first embodiment has the above-described configuration, there is an effect of eliminating the influence of a change other than the target (that is, the “background”) in the image inside the bounding box even if the tracking by the bounding box is performed. With this effect, the target tracking device 100 according to the first embodiment has an effect of suppressing occurrence of a problem of mixed up and loss that may occur when a plurality of targets is tracked.

### Second Embodiment

A target tracking device 100 according to a second embodiment is a modification of the target tracking device 100 according to the present disclosure technology. In the second embodiment, the same reference numerals as those used in the first embodiment are used unless otherwise specified. In the second embodiment, the description overlapping with the first embodiment is appropriately omitted.

FIG. 9 is a block diagram illustrating a functional configuration of the target tracking device 100 according to the second embodiment. As illustrated in FIG. 9, the target tracking device 100 according to the second embodiment includes a predicted feature amount correcting unit 112 in addition to the components described in the first embodiment. As illustrated in FIG. 9, the predicted feature amount correcting unit 112 is connected to other components of the target tracking device 100.

Note that, although not illustrated in FIG. 9 because it becomes complicated, the target tracking device 100 according to the second embodiment also includes the feature amount correcting unit 108 similarly to the configuration illustrated in the first embodiment.

### <<Predicted Feature Amount Correcting Unit 112>>

The predicted feature amount correcting unit 112 is a component for correcting the predicted feature data calculated by the predicting unit 110. Details of correction performed by the predicted feature amount correcting unit 112 will be apparent from the following description.

### <<Processing Content of Target Tracking Device 100 According to Second Embodiment>>

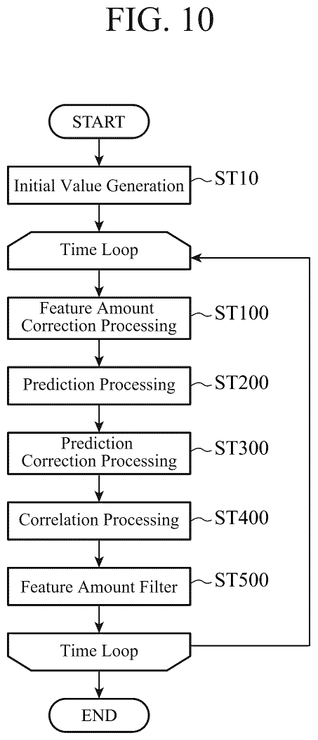

FIG. 10 is a flowchart illustrating processing steps of the target tracking device 100 according to the second embodiment. As illustrated in FIG. 10, the processing steps of the target tracking device 100 according to the second embodiment include a processing step of prediction correction processing ST300 in addition to the processing steps described in the first embodiment. The prediction correction processing ST300 is performed after the prediction processing ST200 and before the correlation processing ST400. The prediction correction processing ST300 is a processing step performed by the predicted feature amount correcting unit 112.

In the present disclosure technology, information of the environment in which the target is present may be considered when predicting the motion of the target. In a case where the target tracking device 100 handles image data, the information of the environment where the target exists may be, for example, vanishing point position information in the image or movement range information of the target.

A vanishing point is a point where groups of parallel straight lines converge in perspective or perspective projection. If the vanishing point is known, the eye level is also known. In a case where the image handled by the target tracking device 100 has a property that can be interpreted as perspective or perspective drawing, the present disclosure technology may predict a motion of a target in consideration of the vanishing point position in the image.

The movement range information of the target may be, for example, sidewalk information in a case where the target is a person, lane information in a case where the target is a vehicle, or the like. The fact that the vanishing point position in the image is known needs that a group of parallel straight lines is shown in the image. For example, the sidewalk information and the lane information can be said to be information that indirectly gives a vanishing point position in an image. Here, the present disclosure technology may make an assumption that “the target does not move away from the ground”. The assumption that “the target does not move away from the ground” is synonymous with “the base of the bounding box (surrounding the target) is not separated from the ground”.

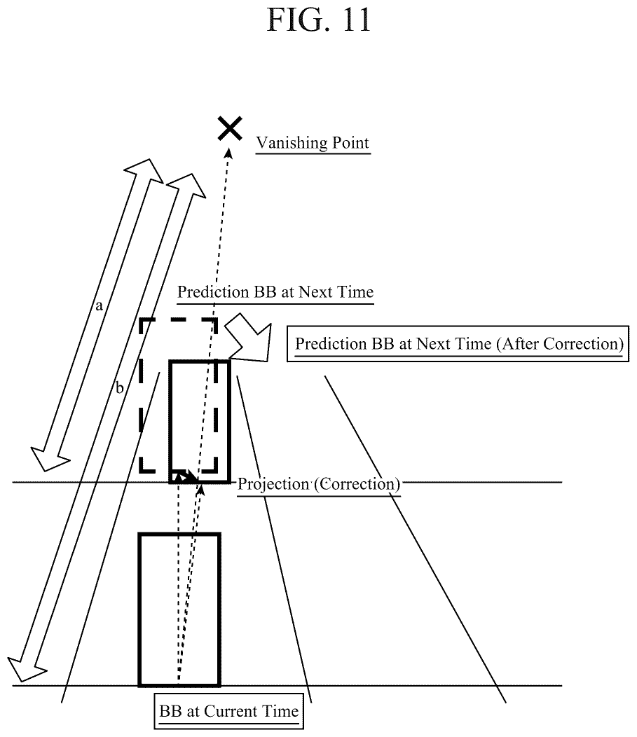

FIG. 11 is a diagram describing prediction of a motion of a target in consideration of a vanishing point position in an image handled by the target tracking device 100 according to the second embodiment.

When the vanishing point in the image is not considered, it is usually considered that the size of the target and the size of the bounding box surrounding the target do not change. In FIG. 11, a rectangle indicated by a broken line in the vicinity of the display of “prediction BB at next time” represents a predicted bounding box in a case where a vanishing point in an image is not considered. The rectangle indicated by the broken line, that is, the predicted bounding box at the next time has the same size as a rectangle indicated by a solid line in the vicinity displayed as “BB at the current time”, that is, the bounding box at the current time.

A slightly small rectangle indicated by a solid line in the vicinity displayed as “prediction BB at next time (after correction)” in FIG. 11 is a predicted bounding box after correction by the predicted feature amount correcting unit 112 based on the vanishing point position in the image. The correction of the predicted feature amount correcting unit 112 based on the vanishing point position in the image only needs to be performed on the basis of the geometric positional relationship with the vanishing point position in the image. The geometric positional relationship with the vanishing point position in the image is a similar triangle with the vanishing point as a vertex in FIG. 11. The ratio between the length of the double-headed arrow marked as “a” and the length of the double-headed arrow marked as “b” in FIG. 11 gives the ratio between the length of the base of the predicted bounding box after correction and the length of the base of the bounding box at the current time. The ratio between the height of the predicted bounding box after correction and the height of the bounding box at the current time is similarly given.

FIG. 11 illustrates a case where there is one vanishing point in the image, but the present disclosure technology is not limited thereto. The present disclosure technology can predict a motion of a target in consideration of the vanishing point in an image even in a case where an image to be handled has a property that can be interpreted as a two-point perspective view or a three-point perspective view.

The predicted feature amount correcting unit 112 may calculate not only the size of the predicted bounding box at the next time but also the place where the predicted bounding box at the next time appears in consideration of the vanishing point position in the image. A sidewalk or a roadway is shown in an image, a vanishing point position in the image is known, and it is assumed that “the target is not away from the ground”. At this time, the predicted feature amount correcting unit 112 can specify a three-dimensional position (hereinafter, referred to as “three-dimensional position”) of the target from the image to some extent. Note that the intention expressed here as “to some extent” is generally that an image captured by a camera is not the same as a drawing by perspective or perspective in a strict sense.

The predicted feature amount correcting unit 112 may predict the three-dimensional position of the bounding box at time k on the basis of a difference from the three-dimensional position of the bounding box at time k−2 to the three-dimensional position of the bounding box at time k−1. In more generalized terms, the predicted feature amount correcting unit 112 may predict the three-dimensional position of the bounding box at the current time on the basis of a difference between the three-dimensional positions of the bounding box at two different past times.

The hardware configuration of the target tracking device 100 according to the second embodiment may also be the same as the configuration described in the first embodiment. That is, the predicted feature amount correcting unit 112 of the target tracking device 100 according to the second embodiment is implemented by a processing circuit.

The function of the predicted feature amount correcting unit 112 is implemented by software, firmware, or a combination of software and firmware, similarly to the functions of the other components.

As described above, since the target tracking device 100 according to the second embodiment has the above configuration, it is possible to predict the three-dimensional motion of the target on the basis of the past three-dimensional position of the target. With this effect, the target tracking device 100 according to the second embodiment has an effect of suppressing occurrence of a problem of mixed up and loss that may occur when a plurality of targets is tracked.

### Third Embodiment

A target tracking device 100 according to a third embodiment is a modification of the target tracking device 100 according to the present disclosure technology. In the third embodiment, the same reference numerals as those used in the foregoing embodiments are used unless otherwise specified. In the third embodiment, the description overlapping with the previously described embodiment is appropriately omitted.

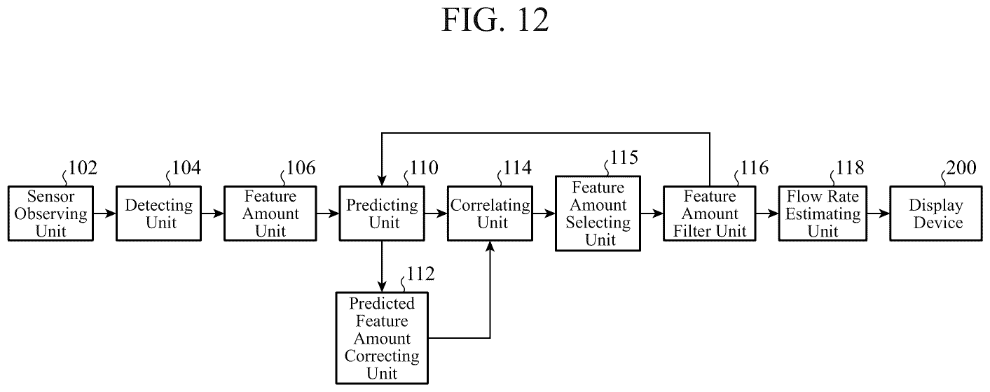

FIG. 12 is a block diagram illustrating a functional configuration of the target tracking device 100 according to the third embodiment. As illustrated in FIG. 12, the target tracking device 100 according to the third embodiment includes a flow rate estimating unit 118 in addition to the configuration described in the second embodiment.

As illustrated in FIG. 12, the flow rate estimating unit 118 is connected to acquire the output from the feature amount filter unit 116 and transmit the flow rate estimated by the flow rate estimating unit 118 to the display device 200.

### <<Flow Rate Estimating Unit 118>>

The flow rate estimating unit 118 is a component for estimating how much the target is flowing, that is, the flow rate for the target. The flow rate of the target corresponds to, for example, a traffic volume when the target is a vehicle.

### <<Processing Content of Target Tracking Device 100 According to Third Embodiment>>

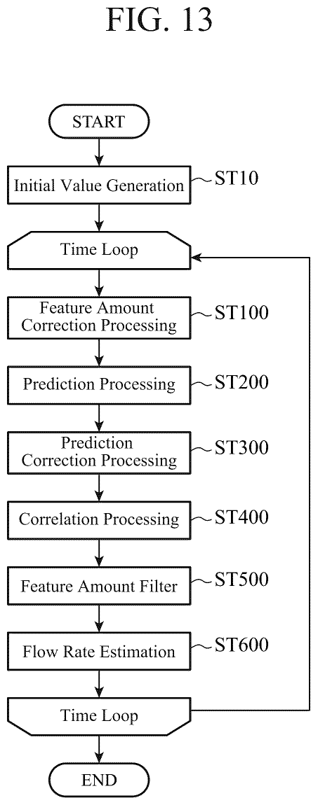

FIG. 13 is a flowchart illustrating processing steps of the target tracking device 100 according to the third embodiment. As illustrated in FIG. 13, the processing steps of the target tracking device 100 according to the third embodiment include a processing step of a flow rate estimation ST600 in addition to the processing steps described in the second embodiment. The flow rate estimation ST600 is performed after the feature amount filter ST500. The flow rate estimation ST600 is a processing step performed by the flow rate estimating unit 118.

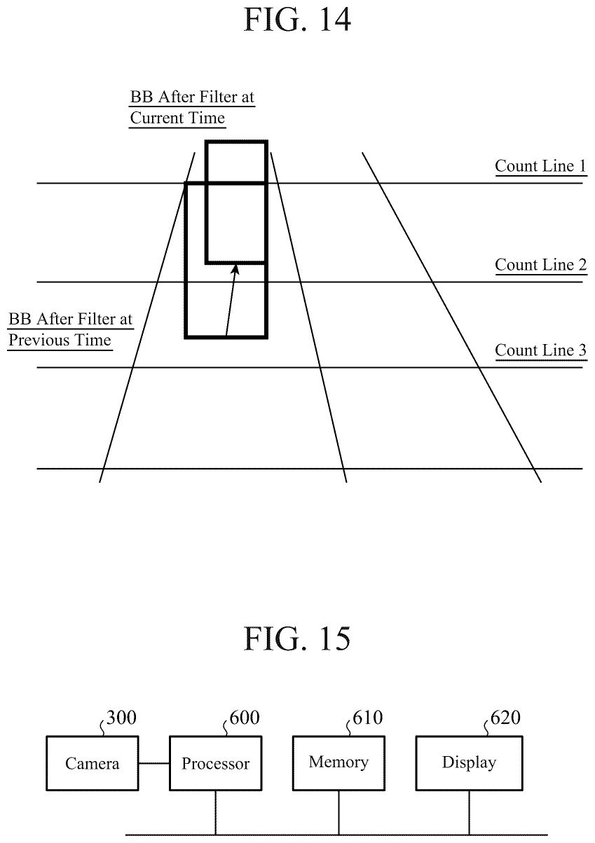

FIG. 14 is a diagram describing a state in which a flow rate for a target is estimated by the present disclosure technology. FIG. 14 illustrates that the target tracking device 100 sets a count line 1, a count line 2, a count lines 3, . . . with respect to an image handled by the present disclosure technology.

In the example of FIG. 14, parallel lines for defining the vanishing point described in the second embodiment are illustrated, and the count line 1, the count line 2, and the count line 3 are set to cross the parallel lines in the order of proximity to the vanishing point.

In the flow rate estimation ST600, the flow rate estimating unit 118 may check a passing target for each of the count line 1, the count lines 2, . . . , and the count line M. For example, in a case where the target tracking device 100 according to the third embodiment targets a moving vehicle, the flow rate estimating unit 118 may count up passing vehicles for each of the count line 1, the count lines 2, . . . , and the count line M at the timing of crossing the count line.

The target tracking device 100 according to the third embodiment can also cause the display device 200 to display information indicating which lane is congested when applied to a road having a plurality of lanes on one side, for example.

Since having the above configuration, the target tracking device 100 according to the third embodiment can grasp the number of passing targets for each count line, and thus, in addition to the effects described in the above-described embodiments, there is an effect that it is possible to specify in which area a target is lost when loss of the target occurs.

Note that the target tracking device 100 according to the present disclosure technology is not limited to the aspects illustrated in the respective embodiments, and may combine the respective embodiments, modify any component of each of the embodiments, or omit any component in each of the embodiments.

### INDUSTRIAL APPLICABILITY

The present disclosure technology can be applied to a tracking device that tracks a target such as a vehicle, and thus has industrial applicability.

### REFERENCE SIGNS LIST

100: target tracking device (target tracker), 102: sensor observing unit, 104: detecting unit, 106: feature amount unit, 108: feature amount correcting unit (feature amount corrector), 108A: dynamic background generating unit (dynamic background generator), 108B: background feature amount vector calculating unit (background feature amount vector calculator), 108C: complementary space projection matrix calculating unit (complementary space projection matrix calculator), 108D: projection vector calculating unit (projection vector calculator), 110: predicting unit (predictor), 112: predicted feature amount correcting unit (predicted feature amount corrector), 114: correlating unit (correlator), 115: feature amount selecting unit, 116: feature amount filter unit, 118: flow rate estimating unit (flow rate estimator), 120: tracking unit, 200: display device, 300: camera, 400: LiDAR, 510: antenna, 520: transceiver, 530: AD converter, 600: processor, 610: memory, 620: display.

What is claimed is:

1. A target tracker that tracks a plurality of targets by a bounding box, the target tracker comprising:
a feature amount corrector including a dynamic background generator, a background feature amount vector calculator, a complementary space projection matrix calculator, and a projection vector calculator, wherein
the dynamic background generator generates a moving image of a background by partially adding a background image of a place where the targets are not shown in a past image to the moving image in a region of the bounding box in which movement of the targets is shown,
the background feature amount vector calculator calculates a background feature amount vector by referring to an image of the background,
the complementary space projection matrix calculator calculates a projection matrix of the background feature amount vector to a complementary space, and
the projection vector calculator multiplies a feature amount vector of the target by the projection matrix.

2. The target tracker according to claim 1, further comprising:
a correlator, wherein
the correlator solves an assignment problem of an existing locus and an observation value for the target.

3. The target tracker according to claim 1, further comprising:
a predictor and a predicted feature amount corrector, wherein
the predictor calculates a predicted value of a feature amount of the target at a current time that has not been determined yet by referring to only a feature amount of the target at a past time, and
the predicted feature amount corrector corrects the predicted value by referring to a vanishing point position in an image.

4. The target tracker according to claim 3, wherein
the predicted feature amount corrector determines a size of the bounding box at the current time by referring to a geometric positional relationship between the vanishing point position and a position of the bounding box.

5. The target tracker according to claim 3, wherein
the predicted feature amount corrector predicts a three-dimensional position of the bounding box at the current time by referring to a difference between three-dimensional positions of the bounding box at two different past times.

6. The target tracker according to claim 3, wherein
the vanishing point position is set by referring to lane information.

7. The target tracker according to claim 2, wherein
the correlator solves the assignment problem using a likelihood ratio.

8. The target tracker according to claim 3, further comprising:
a flow rate estimator, wherein
the flow rate estimator counts a number of the targets passing through a count line, and
the count line is set to cross a parallel line for defining the vanishing point position.
